(19) United States
(12) Patent Application Publication
(10) Pub. No.: US 2025/0071439 A1
(43) Pub. Date: Feb. 27, 2025

(54) SIGNAL PROCESSING DEVICE, SIGNAL PROCESSING METHOD, AND PROGRAM

(71) Applicant: SONY SEMICONDUCTOR SOLUTIONS CORPORATION, KANAGAWA (JP)

(72) Inventor: DAIKI YAMAZAKI, KANAGAWA (JP)

(21) Appl. No.: 18/726,153

(22) PCT Filed: Dec. 27, 2022
(86) PCT No.: PCT/JP2022/048173

§ 371 Date: Jul. 2, 2024

(30) Foreign Application Priority Data
Jan. 12, 2022 (JP) 2022-002749

(51) Int. Cl. H04N 25/585; G06T 5/90; H04N 25/13

(52) U.S. Cl. CPC H04N 25/585; G06T 5/90; H04N 25/134; G06T 2207/20208

(57) ABSTRACT

The present disclosure relates to a signal processing device, a signal processing method, and a program that enable further improvement in image quality. A calculation unit compares a reference signal based on a large-pixel RAW signal of a pixel of interest with a threshold, and calculates a blending ratio for use in blending processing in which a pixel value of a small-pixel RAW signal of the pixel of interest with a pixel value of the large-pixel RAW signal of the pixel of interest. A saturation determination unit compares the pixel value of the large-pixel RAW signal of the pixel of interest with a saturation determination threshold, and outputs a saturation determination value indicating whether or not the large-pixel RAW signal of the pixel of interest is saturated. A selection unit selects, according to the saturation determination value, whether to output the blending ratio as it is or by replacing the blending ratio with 1. The present technology can be applied to, for example, a sensor module that outputs an image with a wide dynamic range.

### TECHNICAL FIELD

The present disclosure relates to a signal processing device, a signal processing method, and a program, in particular to a signal processing device, a signal processing method, and a program that enable further improvement in image quality.

### BACKGROUND ART

Conventionally, the dynamic range of an image can be expanded by performing high dynamic range (HDR) rendering.

For example, Patent Document 1 discloses a solid-state imaging device capable of expanding a dynamic range by combining the potential of a charge-voltage conversion section to which charge is transferred from a high-sensitivity first photoelectric conversion section with the potential of a charge storage section that stores charges generated by a low-sensitivity second photoelectric conversion section.

### CITATION LIST

### Patent Document

Patent Document 1: WO 2016/147885 A

### SUMMARY OF THE INVENTION

### Problems to be Solved by the Invention

However, in the conventional HDR rendering, achieving both suppression of false color occurrence and guarantee of keeping the pixel value unsaturated has not been possible, and thus image quality has been deteriorated in some cases.

The present disclosure has been made in view of such a situation, and an object thereof is to further improve image quality.

### Solutions to Problems

A signal processing device according to one aspect of the present disclosure includes: a calculation unit that compares a reference signal based on a large-pixel RAW signal of a pixel of interest with a threshold, and calculates a blending ratio for use in blending processing in which a pixel value of a small-pixel RAW signal of the pixel of interest is blended with a pixel value of the large-pixel RAW signal of the pixel of interest; a saturation determination unit that compares the pixel value of the large-pixel RAW signal of the pixel of interest with a saturation determination threshold, and outputs a saturation determination value indicating whether or not the large-pixel RAW signal of the pixel of interest is saturated; and a first selection unit that selects, according to the saturation determination value, whether to output the blending ratio as it is or by replacing the blending ratio with 1.

A signal processing method or a program according to one aspect of the present disclosure includes: comparing a reference signal based on a large-pixel RAW signal of a pixel of interest with a threshold and calculating a blending ratio for use in blending processing in which a pixel value of a small-pixel RAW signal of the pixel of interest is blended with a pixel value of the large-pixel RAW signal of the pixel of interest; comparing the pixel value of the large-pixel RAW signal of the pixel of interest with a saturation determination threshold and outputting a saturation determination value indicating whether or not the large-pixel RAW signal of the pixel of interest is saturated; and selecting, according to the saturation determination value, whether to output the blending ratio as it is or by replacing the blending ratio with 1.

According to one aspect of the present disclosure, a reference signal based on a large-pixel RAW signal of a pixel of interest is compared with a threshold and a blending ratio is calculated, the blending ratio for use in blending processing in which a pixel value of a small-pixel RAW signal of the pixel of interest is blended with a pixel value of the large-pixel RAW signal of the pixel of interest; the pixel value of the large-pixel RAW signal of the pixel of interest is compared with a saturation determination threshold and a saturation determination value indicating whether or not the large-pixel RAW signal of the pixel of interest is saturated is output; and whether to output the blending ratio as it is or by replacing the blending ratio with 1 is selected according to the saturation determination value.

### BRIEF DESCRIPTION OF DRAWINGS

FIG. 1 is a block diagram illustrating a configuration example of an embodiment of an image processing unit to which the present technology is applied.

FIG. 2 is a diagram for explaining a pixel value switching method.

FIG. 3 is a diagram for explaining a luminance switching method.

FIG. 4 is a diagram for explaining a maximum value switching method.

FIG. 5 is a block diagram illustrating a configuration example of a blending ratio calculation unit.

FIG. 6 is a diagram for explaining effects of the present technology.

FIG. 7 is a flowchart for explaining blending ratio calculation processing.

FIG. 8 is a block diagram illustrating a configuration example of an image processing system.

FIG. 9 is a block diagram illustrating a configuration example of an imaging device.

FIG. 10 is a diagram illustrating a use example of an image sensor.

### MODE FOR CARRYING OUT THE INVENTION

Hereinafter, specific embodiments to which the present technology is applied will be described in detail with reference to the drawings.

### Configuration Example of Image Processing Unit

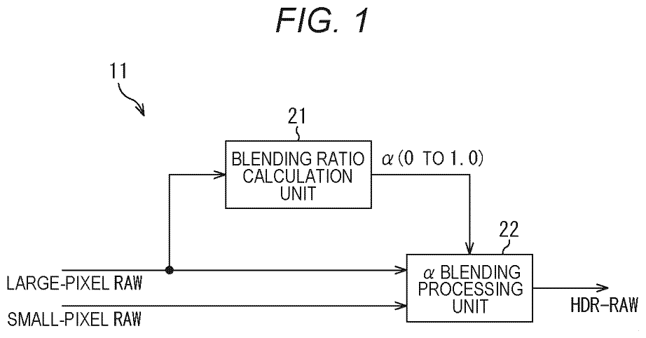

FIG. 1 is a block diagram illustrating a configuration example of an embodiment of an image processing unit to which the present technology is applied.

As illustrated in FIG. 1, a signal processing unit 11 includes a blending ratio calculation unit 21 and an a blending processing unit 22.

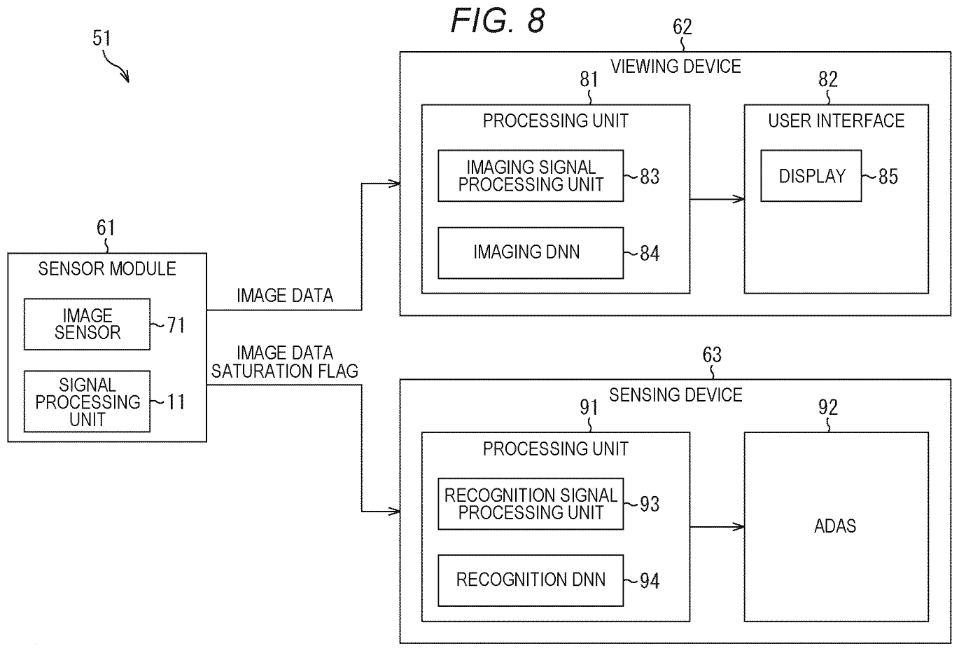

For example, the signal processing unit 11 is used by being incorporated in a sensor module 61 as illustrated in FIG. 8 to be described later, and the sensor module 61 includes an image sensor 71 including a high-sensitivity large pixel having a photodiode with a large area and a low-sensitivity small pixel having a photodiode with a small area. Then, the signal processing unit 11 receives a large-pixel RAW signal that is a pixel signal according to the amount of light received by the large pixel and a small-pixel RAW signal that is a pixel signal according to the amount of light received by the small pixel.

The large-pixel RAW signal input to the signal processing unit 11 is supplied to the blending ratio calculation unit 21 and the α blending processing unit 22, and the small-pixel RAW signal input to the signal processing unit 11 is supplied to the α blending processing unit 22. Then, the signal processing unit 11 outputs an HDR-RAW signal that is a pixel signal with an extended dynamic range.

The blending ratio calculation unit 21 calculates a blending ratio α that is a value representing the degree of saturation of the large pixel by an index of 0 to 1.0, and supplies the blending ratio α to the α blending processing unit 22. Note that a detailed configuration of the blending ratio calculation unit 21 will be described later with reference to FIG. 5.

The α blending processing unit 22 performs blending processing (HDR-RAW signal=large-pixel RAW signal×(1.0−α)+small-pixel RAW signal×α) in which the small-pixel RAW signal is blended with the large-pixel RAW signal according to the blending ratio α supplied from the blending ratio calculation unit 21, thereby generating an HDR-RAW signal.

Here, when calculating the blending ratio α of a pixel of interest that is a pixel for which the blending ratio α is to be calculated, the blending ratio calculation unit 21 compares a reference signal BASE based on the large-pixel RAW signal of the pixel of interest with a predetermined lower limit threshold and a predetermined upper limit threshold. For example, in a case where the reference signal BASE is equal to or lower than the lower limit threshold, the blending ratio calculation unit 21 calculates 0 as the blending ratio α. Furthermore, in a case where the reference signal BASE is between the lower limit threshold and the upper limit threshold, the blending ratio calculation unit 21 calculates, as the blending ratio α, a value that increases from 0 to 1.0 in accordance with the increase in the reference signal BASE. In addition, in a case where the reference signal BASE is equal to or higher than the upper limit threshold, the blending ratio calculation unit 21 calculates 1.0 as the blending ratio α.

In this regard, the blending ratio calculation unit 21 can calculate the blending ratio α by using, as the reference signal BASE, any one of the pixel value of the large-pixel RAW signal of the pixel of interest, the luminance value calculated from pixel values of a plurality of pixels with the pixel of interest being the center, and the maximum value that is the maximum pixel value among the pixel values of the plurality of pixels with the pixel of interest being the center. Hereinafter, a method of calculating the blending ratio α using the pixel value of the large-pixel RAW signal of the pixel of interest as the reference signal BASE is referred to as a pixel value switching method. Furthermore, a method of calculating the blending ratio α using the luminance value calculated from pixel values of a plurality of pixels with the pixel of interest being the center as the reference signal BASE is referred to as a luminance switching method. In addition, a method of calculating the blending ratio α using the maximum value that is the maximum pixel value among the pixel values of the plurality of pixels with the pixel of interest being the center as the reference signal BASE is referred to as a maximum value switching method.

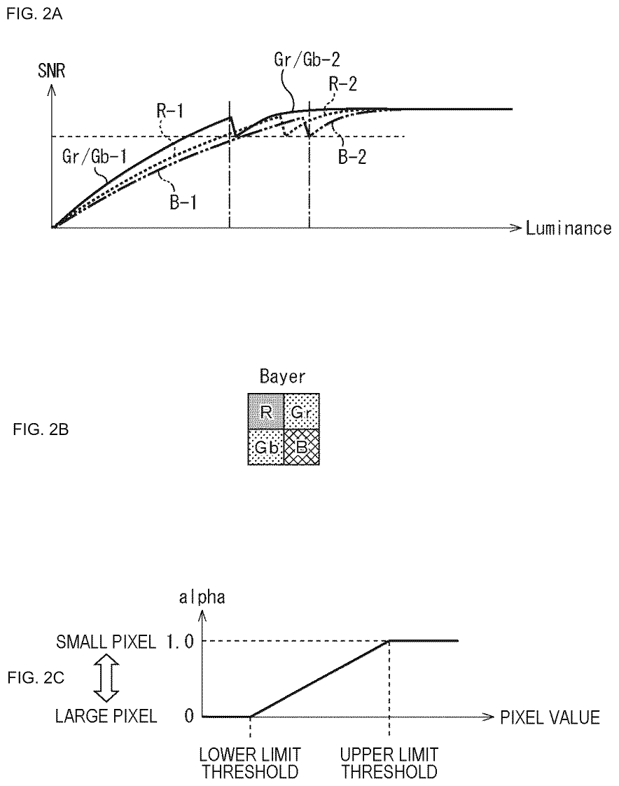

The pixel value switching method, the luminance switching method, and the maximum value switching method will be described with reference to FIGS. 2 to 4.

FIG. 2 is a diagram for explaining the pixel value switching method.

A of FIG. 2 illustrates a relationship between the luminance of light received by a pixel and an SN ratio in the pixel value switching method.

In the pixel value switching method, for example, the pixel value of the large-pixel RAW signal of the pixel of interest is compared with a threshold for each red pixel, green pixel, and blue pixel in the Bayer array as illustrated in B of FIG. 2. Then, on the basis of the comparison result, switching is performed between the pixel value of the large-pixel RAW signal and the pixel value of the small-pixel RAW signal.

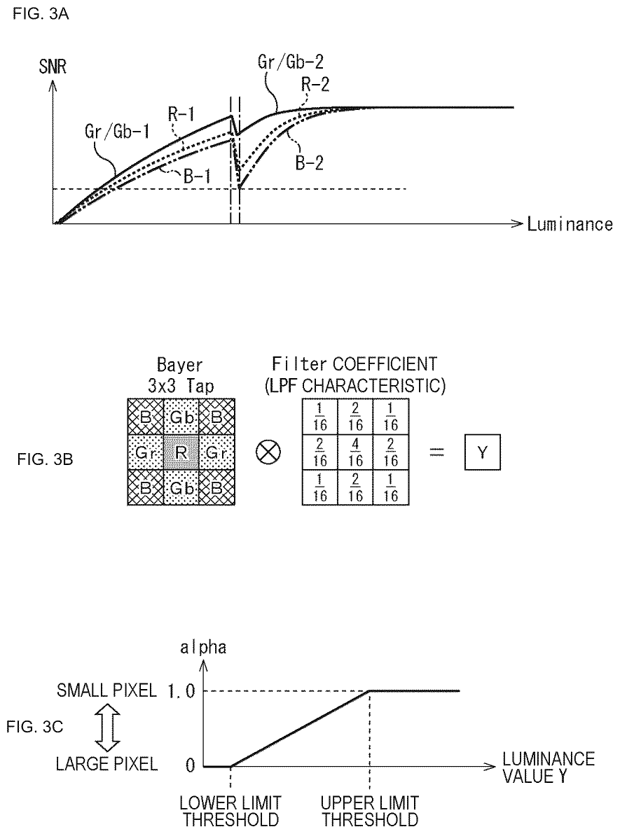

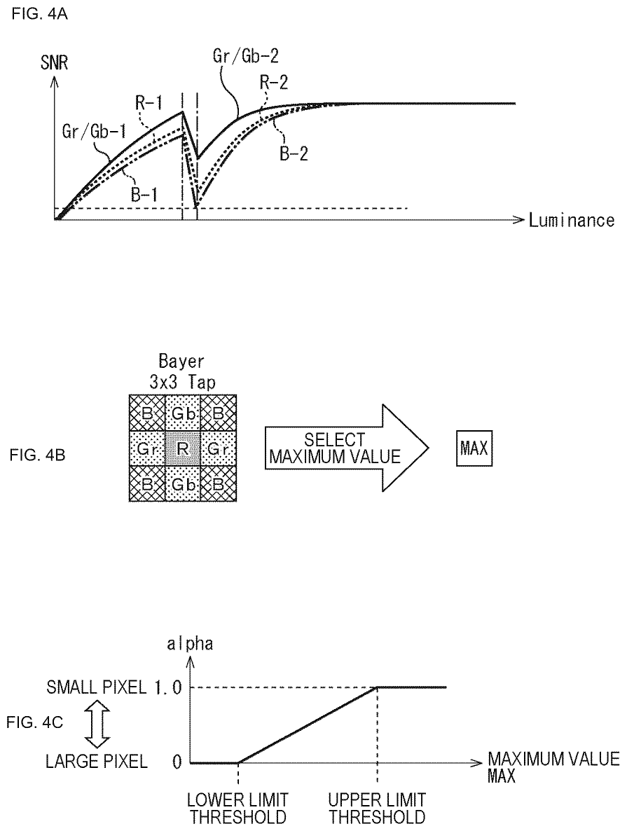

Thus, the pixel value switching method is more advantageous than the luminance switching method (see A of FIG. 3) and the maximum value switching method (see A of FIG. 4) in that the minimum value of the SN ratio indicated by the dashed line in A of FIG. 2 is secured not to be low (hereinafter, also referred to as saturation guarantee).

However, in the pixel value switching method, the luminance at which a pixel value Gr/Gb-1 of a green large-pixel RAW signal and a pixel value Gr/Gb-2 of a green small-pixel RAW signal are switched, the luminance at which a pixel value R-1 of a red large-pixel RAW signal and a pixel value R-2 of a red small-pixel RAW signal are switched, and the luminance at which a pixel value B-1 of a blue large-pixel RAW signal and a pixel value B-2 of a blue small-pixel RAW signal are switched are significantly different from each other. Therefore, in the range of luminance defined by the dash-dotted lines in A of FIG. 2, a situation occurs in which a combination of the pixel value Gr/Gb-2 of the green small pixel, the pixel value R-1 of the red large pixel, and the pixel value B-1 of the blue large pixel, or a combination of the pixel value Gr/Gb-2 of the green small pixel, the pixel value R-2 of the red small pixel, and the pixel value B-1 of the blue large pixel is used. In this regard, due to a difference in SN ratio, a deviation in linearity, or the like between the large-pixel RAW signal and the small-pixel RAW signal of each color, there is a possibility that the color finally appears as a false color in the image in this luminance range (hereinafter, also referred to as connection coloring).

Furthermore, since determination is performed using the pixel value in the pixel value switching method, the pixel value switching method is more advantageous than the luminance switching method and the maximum value switching method in that the large-pixel RAW signal having a good SN ratio can be used until immediately before the large-pixel RAW signal is saturated (or immediately before the upper limit threshold indicated in C of FIG. 2) (hereinafter, referred to as a connection SN ratio).

As described above, the pixel value switching method is characterized in that the connection SN ratio is good, saturation guarantee is possible, and connection coloring easily occurs.

FIG. 3 is a diagram for explaining the luminance switching method.

A of FIG. 3 illustrates a relationship between the luminance of light received by a pixel and an SN ratio in the luminance switching method.

In the luminance switching method, for example, by using a filter coefficient having a low-pass filter characteristic as illustrated in B of FIG. 3, the luminance of the pixel of interest is calculated from pixel values of the large-pixel RAW signals of a 3-by-3 tap around the pixel of interest as the center, and the luminance value is compared with a threshold. Then, on the basis of the comparison result, switching is performed between the pixel value of the large-pixel RAW signal and the pixel value of the small-pixel RAW signal.

Thus, in the luminance switching method, the difference in sensitivity of pixels of each color is smoothed by the filter coefficient, and as a result, the luminance at which the pixel value Gr/Gb-1 of the green large-pixel RAW signal and the pixel value Gr/Gb-2 of the green small-pixel RAW signal are switched, the luminance at which the pixel value R-1 of the red large-pixel RAW signal and the pixel value R-2 of the red small-pixel RAW signal are switched, and the luminance at which the pixel value B-1 of the blue large-pixel RAW signal and the pixel value B-2 of the blue small-pixel RAW signal are switched are substantially the same. Therefore, the range of luminance defined by the dash-dotted lines in A of FIG. 3 is narrowed and false colors are less likely to occur, which is more advantageous than the pixel value switching method (see A of FIG. 2).

In the luminance switching method, however, since the color balance varies depending on the color temperature or the color of the subject, the minimum value of the SN ratio indicated by the dashed line in A of FIG. 3 cannot be secured.

In addition, in the luminance switching method, saturation of the large-pixel RAW signal is reduced by the filter processing, and thus, it is necessary to set the upper limit threshold illustrated in C of FIG. 3 to a lower value than that in the pixel value switching method, and the SN ratio deteriorates at and around the luminance at which switching is performed.

As described above, the luminance switching method is characterized in that the connection SN ratio is slightly poor, saturation guarantee is impossible, and connection coloring hardly occurs.

FIG. 4 is a diagram for explaining the maximum value switching method.

A of FIG. 4 illustrates the relationship between the luminance of light received by a pixel and the SN ratio in the maximum value switching method.

In the maximum value switching method, for example, the maximum value among the pixel values of the large-pixel RAW signals of a 3-by-3 tap around the pixel of interest as the center as illustrated in B of FIG. 4 is selected, and the maximum value is compared with a threshold. Then, on the basis of the comparison result, switching is performed between the pixel value of the large-pixel RAW signal and the pixel value of the small-pixel RAW signal.

Thus, in the maximum value switching method, the luminance at which the pixel value Gr/Gb-1 of the green large-pixel RAW signal and the pixel value Gr/Gb-2 of the green small-pixel RAW signal are switched, the luminance at which the pixel value R-1 of the red large-pixel RAW signal and the pixel value R-2 of the red small-pixel RAW signal are switched, and the luminance at which the pixel value B-1 of the blue large-pixel RAW signal and the pixel value B-2 of the blue small-pixel RAW signal are switched are substantially the same. In this regard, the range of luminance defined by the dash-dotted lines in A of FIG. 4 is narrowed and false colors are less likely to occur, which is more advantageous than the pixel value switching method (see A of FIG. 2).

In the maximum value switching method, however, since switching of large-pixel RAW signals of all colors occurs at a stage at which the large-pixel RAW signal of the color with the highest sensitivity is saturated, the minimum value of the SN ratio indicated by the dashed line in A of FIG. 4 is lower than those in the pixel value switching method (see A of FIG. 2) and the luminance switching method (see A of FIG. 3).

In addition, since determination is performed using the maximum value of the large-pixel RAW signal in the maximum value switching method, it is more advantageous than the pixel value switching method and the luminance switching method in that saturation of the large-pixel RAW signal can be reliably prevented from being output.

As described above, the maximum value switching method is characterized in that the connection SN ratio is poor, saturation guarantee is possible, and connection coloring is slightly likely to occur.

As described with reference to FIGS. 2 to 4, the pixel value switching method, the luminance switching method, and the maximum value switching method have respective characteristics, but achieving both suppression of false color occurrence and guarantee of keeping the pixel value unsaturated has not been possible.

In this regard, the blending ratio calculation unit 21 has a function of determining whether or not a large pixel as a pixel of interest is saturated. For example, in a case where the blending ratio calculation unit 21 determines that the large pixel as the pixel of interest is not saturated, the blending ratio α obtained by any of the pixel value switching method, the luminance switching method, and the maximum value switching method can be used as it is. For example, in the signal processing unit 11, it is preferable to use, as a base, the blending ratio α obtained by the luminance switching method in which connection coloring hardly occurs. On the other hand, in a case where the blending ratio calculation unit 21 determines that the large pixel as the pixel of interest is saturated, the blending ratio α of 1 can be used. In this regard, achieving both suppression of false color occurrence and guarantee of keeping the pixel value unsaturated is possible, and thus image quality of an image based on an HDR-RAW signal can be improved.

### Configuration Example of Blending Ratio Calculation Unit

FIG. 5 is a block diagram illustrating a configuration example of the blending ratio calculation unit 21.

As illustrated in FIG. 5, the blending ratio calculation unit 21 includes a first tap generation unit 31, a luminance generation unit 32, a maximum value selection unit 33, a saturation determination unit 34, a first selector 35, a calculation unit 36, a second selector 37, a second tap generation unit 38, a low-pass filter processing unit 39, and a third selector 40.

The first tap generation unit 31 generates, from large-pixel RAW signals sequentially supplied to the blending ratio calculation unit 21, pixel values of the large-pixel RAW signals of a 3-by-3 tap with a pixel of interest being the center that is a target pixel for which the blending ratio α is to be calculated, and supplies the generated pixel values to the luminance generation unit 32 and the maximum value selection unit 33.

The luminance generation unit 32 calculates a luminance value Y of the pixel of interest by multiplying the pixel values of the large-pixel RAW signals of the 3-by-3 tap by the filter coefficient (see B of FIG. 3 described above), and supplies the luminance value Y to the first selector 35.

The maximum value selection unit 33 selects a maximum value MAX among the pixel values of the large-pixel RAW signals of the 3-by-3 tap, and supplies the maximum value MAX to the first selector 35.

The saturation determination unit 34 compares the pixel value of the large-pixel RAW signal of the pixel of interest with a saturation determination threshold SATU_TH, and outputs a 1-bit saturation determination value SATU on the basis of the comparison result. For example, in a case where the pixel value of the large-pixel RAW signal of the pixel of interest exceeds the saturation determination threshold SATU_TH, the saturation determination unit 34 outputs, as the saturation determination value SATU, 1 indicating that the large pixel is saturated. On the other hand, in a case where the pixel value of the large-pixel RAW signal of the pixel of interest does not exceed the saturation determination threshold SATU_TH, the saturation determination unit 34 outputs, as the saturation determination value SATU, 0 indicating that the large pixel is not saturated. The saturation determination value SATU output from the saturation determination unit 34 is supplied to the second selector 37 and also is output to the outside of the blending ratio calculation unit 21 (to a processing block at a subsequent stage, which is not illustrated).

The first selector 35 selects any one of the pixel value of the large-pixel RAW signal of the pixel of interest, the luminance value Y generated by the luminance generation unit 32, and the maximum value MAX selected by the maximum value selection unit 33 as the reference signal BASE according to the setting of a register, and supplies the reference signal BASE to the calculation unit 36.

The calculation unit 36 calculates the blending ratio α in accordance with the reference signal BASE supplied from the first selector 35, and supplies the blending ratio α to the second selector 37. That is, in a case where the reference signal BASE is equal to or lower than the lower limit threshold, the calculation unit 36 calculates 0 as the blending ratio α. Furthermore, in a case where the reference signal BASE is between the lower limit threshold and the upper limit threshold, the calculation unit 36 calculates, as the blending ratio α, a value that increases from 0 to 1.0 in accordance with the increase in the reference signal BASE. In addition, in a case where the reference signal BASE is equal to or higher than the upper limit threshold, the calculation unit 36 calculates 1.0 as the blending ratio α.

The second selector 37 selects the blending ratio α on the basis of the saturation determination value SATU supplied from the saturation determination unit 34 and supplies the blending ratio α to the second tap generation unit 38. For example, in a case where the saturation determination value SATU is not 1, that is, in a case where the saturation determination value SATU is 0, the second selector 37 outputs the blending ratio α supplied from the calculation unit 36 as it is. On the other hand, in a case where the saturation determination value SATU is 1, the second selector 37 outputs 1 as the blending ratio α. That is, in a case where the saturation determination value SATU is 1, it is determined that the large pixel is saturated, and the blending ratio α is forcibly replaced with 1.

The second tap generation unit 38 generates, from the blending ratios α sequentially supplied from the second selector 37, blending ratios α of the 3-by-3 tap with the pixel of interest being the center, and supplies the blending ratios α to the low-pass filter processing unit 39 and the third selector 40.

The low-pass filter processing unit 39 applies a low-pass filter (simple arithmetic average) to the blending ratios α of the 3-by-3 tap supplied from the second tap generation unit 38, and supplies the low-pass filtered blending ratio α of the pixel of interest to the third selector 40. As described above, by applying the low-pass filter, even in a case where the blending ratio α changes steeply in the spatial direction, it is possible to prevent colored appearance after rendering.

In a case where the blending ratio α of the pixel of interest that is not low-pass filtered is 1, the third selector 40 outputs the blending ratio α as it is according to the blending ratio α of the pixel of interest that is not low-pass filtered. On the other hand, in a case where the blending ratio α of the pixel of interest that is not low-pass filtered is not 1, the third selector 40 outputs the low-pass filtered blending ratio α. That is, in a case where a portion having the blending ratio α of 1 is low-pass filtered and the resulting blending ratio α is 1 or less, it is assumed that saturation guarantee will not be available and thus, the portion having the blending ratio α of 1 is configured not to be low-pass filtered.

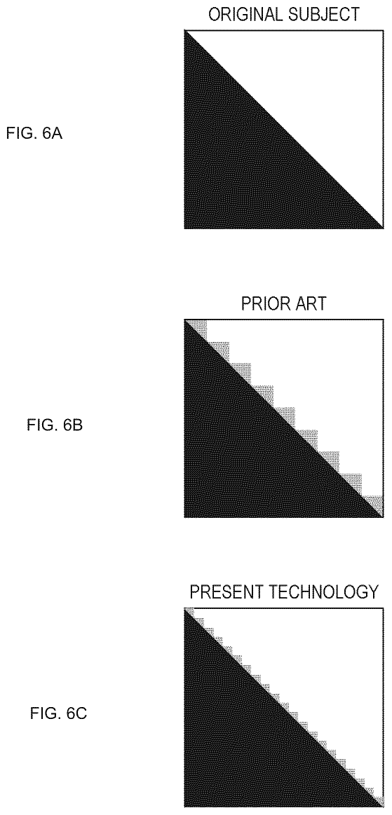

With reference to FIG. 6, effects in using the blending ratio α calculated by the blending ratio calculation unit 21 will be described.

A of FIG. 6 illustrates an original subject. The white region is a bright region for which the small-pixel RAW signal is used, and the black region is a dark region for which the large-pixel RAW signal is used. Then, the boundary between the white region and the black region has a large contrast, and the blending processing is performed on this boundary.

B of FIG. 6 illustrates an image to which the blending processing has been performed using the blending ratio α obtained by the prior art. As illustrated in the drawing, in the prior art, the boundary between the white region and the black region tends to be rough and there is a possibility that color artifacts occur, or saturation of pixels that are not supposed to be output is output. In this regard, reliability of data may be lost. In other words, the pixel value switching method, the luminance switching method, and the maximum value switching method have failed to achieve both suppression of false color occurrence and guarantee of keeping the pixel value unsaturated.

C of FIG. 6 illustrates an image to which the blending processing has been performed using the blending ratio α obtained by the present technology. As illustrated in the drawing, in the present technology, roughness and color artifacts at the boundary between the white region and the black region are suppressed as compared with the prior art, and the appearance is closer to the original subject. Furthermore, since it is guaranteed that saturation of the large-pixel RAW signal is not output, reliability of data is high. That is, in the present technology, on the basis of the luminance switching method in which the luminance value Y generated from the pixel values of a plurality of (for example, 3-by-3 tap) pixels with the pixel of interest being the center is used as the reference signal BASE, the saturation determination unit 34 performs saturation determination of the pixel value of the large-pixel RAW signal, thereby achieving both suppression of false color occurrence and guarantee of keeping the pixel value unsaturated.

### Processing Example of Blending Ratio Calculation Processing

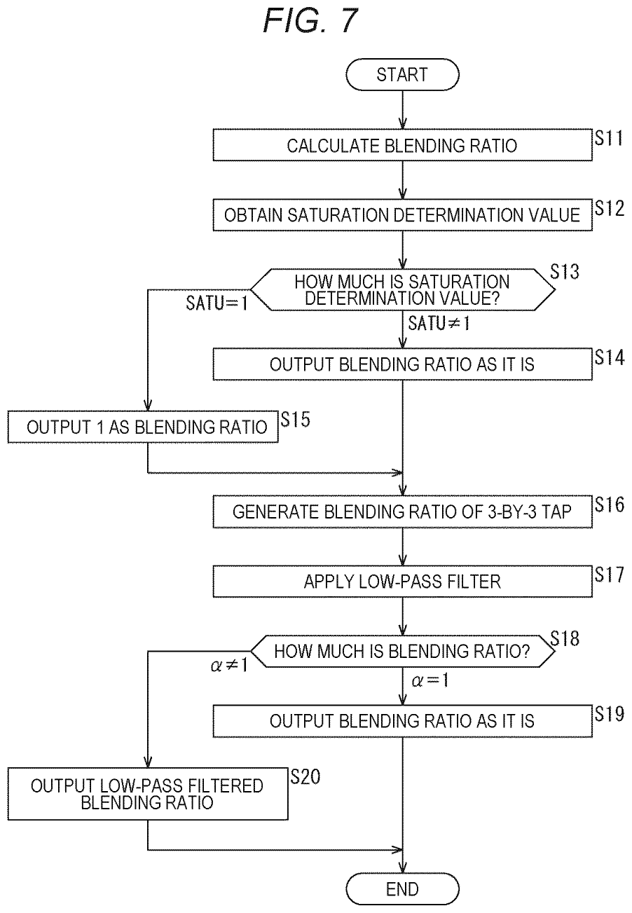

FIG. 7 is a flowchart for explaining blending ratio calculation processing performed by the blending ratio calculation unit 21.

In step S11, the calculation unit 36 calculates a blending ratio α in accordance with the reference signal BASE supplied from the first selector 35, and supplies the blending ratio α to the second selector 37. Here, as the reference signal BASE, any one of the pixel value of the large-pixel RAW signal of the pixel of interest, the luminance value Y generated by the luminance generation unit 32, and the maximum value MAX selected by the maximum value selection unit 33 can be selected, but basically, false color occurrence can be suppressed by selecting the luminance value Y.

In step S12, the saturation determination unit 34 compares the pixel value of the large-pixel RAW signal of the pixel of interest with the saturation determination threshold SATU_TH, and obtains the saturation determination value SATU from the comparison result. Then, the saturation determination unit 34 supplies the saturation determination value SATU to the second selector 37 and also outputs the saturation determination value SATU to the outside of the blending ratio calculation unit 21.

In step S13, the second selector 37 determines whether or not the saturation determination value SATU supplied from the saturation determination unit 34 in step S12 is 1.

If it is determined in step S13 that the saturation determination value SATU is not 1 (that is, SATU=0), the processing proceeds to step S14, and the second selector 37 outputs the blending ratio α supplied from the calculation unit 36 in step S11 as it is and supplies the blending ratio α to the second tap generation unit 38.

On the other hand, if it is determined in step S13 that the saturation determination value SATU is 1, the processing proceeds to step S15, and the second selector 37 outputs 1 as the blending ratio α and supplies the blending ratio α to the second tap generation unit 38.

After the processing of step S14 or step S15, the processing proceeds to step S16, and the second tap generation unit 38 generates blending ratios α of the 3-by-3 tap with the pixel of interest being the center and supplies the blending ratios α to the low-pass filter processing unit 39 and the third selector 40.

In step S17, the low-pass filter processing unit 39 applies a low-pass filter to the blending ratios α of the 3-by-3 tap supplied from the second tap generation unit 38, and supplies the low-pass filtered blending ratio α of the pixel of interest to the third selector 40.

In step S18, the third selector 40 determines whether or not the blending ratio α of the pixel of interest supplied from the second tap generation unit 38 in step S16 and not low-pass filtered is 1.

In step S18, if it is determined that the blending ratio α of the pixel of interest not low-pass filtered is 1, the processing proceeds to step S19 and the third selector 40 outputs the blending ratio α of the pixel of interest not low-pass filtered as it is.

On the other hand, in step S18, if it is determined that the blending ratio α of the pixel of interest not low-pass filtered is not 1, the processing proceeds to step S20, and the third selector 40 outputs the low-pass filtered blending ratio α of the pixel of interest supplied from the low-pass filter processing unit 39 in step S17.

After processing of step S19 or S20, the processing ends.

As described above, the blending ratio calculation unit 21 can calculate a blending ratio α having characteristics that the connection SN ratio is relatively good, saturation guarantee is possible, and connection coloring is less likely to occur.

### Configuration Example of Image Processing System

FIG. 8 is a block diagram illustrating a configuration example of an image processing system including the signal processing unit 11.

As illustrated in FIG. 8, an image processing system 51 includes the sensor module 61, a viewing device 62, and a sensing device 63.

The sensor module 61 includes the image sensor 71 and the signal processing unit 11. The image sensor 71 has a subpixel structure including a high-sensitivity large pixel and a low-sensitivity small pixel, and supplies a large-pixel RAW signal output from the large pixel and a small-pixel RAW signal output from the small pixel to the signal processing unit 11.

The signal processing unit 11 outputs image data of an HDR-RAW signal obtained by the blending processing performed by the α blending processing unit 22 according to the blending ratio α calculated by the blending ratio calculation unit 21. In addition, the signal processing unit 11 outputs the saturation determination value SATU obtained by the saturation determination unit 34 as a saturation flag.

The viewing device 62 includes a processing unit 81 and a user interface 82. The processing unit 81 includes an imaging signal processing unit 83 and an imaging deep neural network (DNN) 84, and the user interface 82 includes a display 85. The image data output from the signal processing unit 11 is supplied to the viewing device 62, the imaging signal processing unit 83 performs imaging signal processing on the image data, and the imaging DNN 84 performs deep learning for imaging with respect to the image data. Then, an image based on the image data to which the imaging signal processing has been applied is displayed on the display 85, and a recognition result recognized by imaging deep learning with respect to the image data is displayed on the display 85.

The sensing device 63 includes a processing unit 91 and an advanced driver-assistance system (ADAS) 92. The processing unit 91 includes a recognition signal processing unit 93 and a recognition DNN 94. The image data and the saturation flag output from the signal processing unit 11 are supplied to the sensing device 63, the recognition signal processing unit 93 performs recognition signal processing on the image data with reference to the saturation flag, and the recognition DNN 94 performs recognition deep learning with respect to the image data with reference to the saturation flag. Then, the image data to which the recognition signal processing has been applied and the recognition result recognized by the recognition deep learning with respect to the image data are supplied to the ADAS 92, and the ADAS 92 performs vehicle control.

As described above, the sensing device 63 performs the recognition signal processing on the image data with reference to the saturation flag and the recognition deep learning with respect to the image data with reference to the saturation flag. In this regard, erroneous recognition can be avoided.

For example, in a case where intense light suddenly enters the sensor module 61, the signal processing unit 11 can determine whether or not the large-pixel RAW signal is saturated, and supply the saturation flag to the sensing device 63 together with the image data. As described above, the information of the saturation flag (saturation determination value SATU) indicates the timing at which the pixel value of the large-pixel RAW signal and the pixel value of the small-pixel RAW signal are switched. Therefore, in the sensing device 63, it is possible to switch between the recognition signal processing and the recognition deep learning algorithm suitable for the large-pixel RAW signal and the recognition signal processing and the recognition deep learning algorithm suitable for the small-pixel RAW signal in accordance with the saturation flag.

For example, in the recognition signal processing and the recognition deep learning algorithm suitable for the large-pixel RAW signal, processing specialized for a dark portion can be performed (for example, noise is removed by applying strong noise reduction before recognition). Furthermore, in the recognition signal processing and the recognition deep learning algorithm suitable for the small-pixel RAW signal, processing specialized for a bright portion can be performed (for example, removal of solar flare).

As described above, the image processing system 51 can perform recognition signal processing and recognition deep learning optimal for each level of luminance, thereby improving the recognition rate and avoiding erroneous recognition.

Note that the present invention can also be applied to HDR rendering for, for example, other than the subpixel structure. Furthermore, the coefficient used by the low-pass filter processing unit 39 in applying a low-pass filter to the blending ratios α of a 3-by-3 tap may be other than the coefficient of arithmetic averaging. Alternatively, the low-pass filter processing unit 39 may store a plurality of coefficients and select a coefficient as necessary.

### Configuration Example of Electronic Apparatus

The sensor module 61 including the signal processing unit 11 as described above can be applied to various electronic apparatuses, for example, an imaging system such as a digital still camera or a digital video camera, a mobile phone having an imaging function, or other apparatuses having an imaging function.

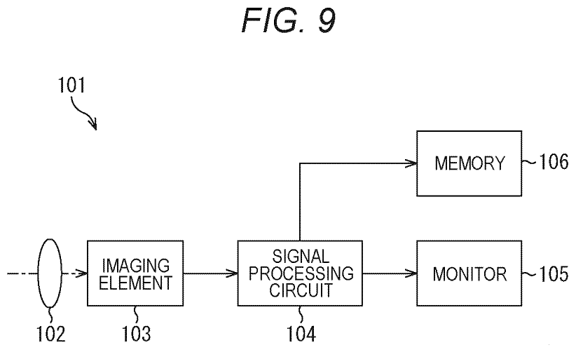

FIG. 9 is a block diagram illustrating a configuration example of an imaging device mounted on an electronic apparatus.

As illustrated in FIG. 9, an imaging device 101 includes an optical system 102, an imaging element 103, a signal processing circuit 104, a monitor 105, and a memory 106, and can capture a still image and a moving image.

The optical system 102 includes one or a plurality of lenses, guides image light (incident light) from a subject to the imaging element 103, and forms an image on a light-receiving surface (sensor unit) of the imaging element 103.

The sensor module 61 described above is applied as the imaging element 103. Electrons are accumulated in the imaging element 103 for a certain period in accordance with the image formed on the light-receiving surface via the optical system 102. Then, a signal corresponding to the electrons accumulated in the imaging element 103 is supplied to the signal processing circuit 104.

The signal processing circuit 104 performs various types of signal processing on a pixel signal output from the imaging element 103. An image (image data) obtained by the signal processing applied by the signal processing circuit 104 is supplied to the monitor 105 to be displayed or supplied to the memory 106 to be stored (recorded).

The imaging device 101 configured as described above can capture, for example, a higher quality image by applying the sensor module 61 including the above-described signal processing unit 11.

### Use Example of Image Sensor

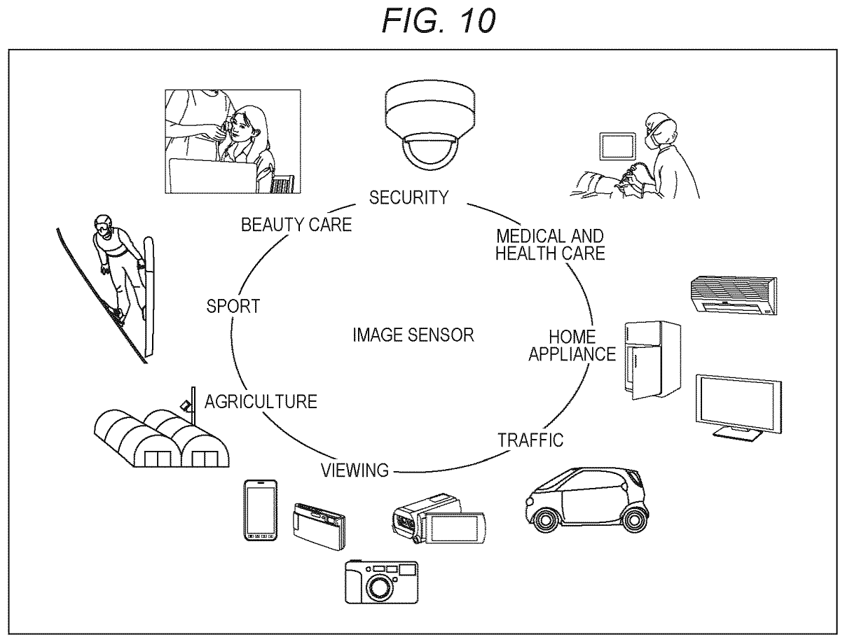

FIG. 10 is a diagram illustrating a use example of the above-mentioned image sensor (imaging element).

The image sensor described above can be used in various cases for sensing light such as visible light, infrared light, ultraviolet light, and X-ray as described below, for example.
A device that captures an image to be used for viewing, such as a digital camera and a portable device with a camera function
A device for traffic purpose such as an in-vehicle sensor that takes images of the front, rear, surroundings, interior and the like of an automobile, a surveillance camera for monitoring traveling vehicles and roads, and a ranging sensor that measures a distance between vehicles and the like for safe driving such as automatic stop, recognition of a driver's condition and the like
A device for home appliances such as a television, a refrigerator, and an air conditioner that image a user's gesture and perform device operation according to the gesture
A device for medical and health care use such as an endoscope and a device that performs angiography by receiving infrared light
A device for security use such as a security monitoring camera and an individual authentication camera
A device used for beauty care, such as a skin measuring instrument for photographing skin, and a microscope for photographing the scalp
A device for sporting use such as an action camera and a wearable camera for sporting use and the like
A device used for agriculture, such as a camera for monitoring a condition of a field or crop

### Example of Combinations of Configurations

Note that the present technology can also have the following configurations.

(1)

A signal processing device including:
a calculation unit that compares a reference signal based on a large-pixel RAW signal of a pixel of interest with a threshold, and calculates a blending ratio for use in blending processing in which a pixel value of a small-pixel RAW signal of the pixel of interest is blended with a pixel value of the large-pixel RAW signal of the pixel of interest;
a saturation determination unit that compares the pixel value of the large-pixel RAW signal of the pixel of interest with a saturation determination threshold, and outputs a saturation determination value indicating whether or not the large-pixel RAW signal of the pixel of interest is saturated; and
a first selection unit that selects, according to the saturation determination value, whether to output the blending ratio as it is or by replacing the blending ratio with 1.
   (2)

The signal processing device according to (1) above, in which
a luminance value calculated from pixel values of a plurality of pixels with the pixel of interest being a center is used as the reference signal.
   (3)

The signal processing device according to (1) or (2) above, further including:
a tap generation unit that generates the blending ratio of a tap within a predetermined range with the pixel of interest being a center from the blending ratio output from the first selection unit; and
a low-pass filter processing unit that applies a low-pass filter to the blending ratio of the tap.
   (4)

The signal processing device according to (3) above, further including
a second selection unit that outputs the blending ratio as it is in a case where the blending ratio of the pixel of interest before application of the low-pass filter is 1, and outputs the blending ratio of the pixel of interest after application of the low-pass filter in a case where the blending ratio of the pixel of interest before application of the low-pass filter is not 1.
   (5)

The signal processing device according to any one of (1) to (4) above, in which
the saturation determination value is output as a saturation flag to be referred to by a sensing device that performs recognition processing using an image with a wide dynamic range, the image to which the blending processing has been applied.
   (6)

A signal processing method including:
comparing a reference signal based on a large-pixel RAW signal of a pixel of interest with a threshold and calculating a blending ratio for use in blending processing in which a pixel value of a small-pixel RAW signal of the pixel of interest is blended with a pixel value of the large-pixel RAW signal of the pixel of interest;
comparing the pixel value of the large-pixel RAW signal of the pixel of interest with a saturation determination threshold and outputting a saturation determination value indicating whether or not the large-pixel RAW signal of the pixel of interest is saturated; and
selecting, according to the saturation determination value, whether to output the blending ratio as it is or by replacing the blending ratio with 1.
   (7)

A program for causing a computer of a signal processing device to perform signal processing including:
comparing a reference signal based on a large-pixel RAW signal of a pixel of interest with a threshold and calculating a blending ratio for use in blending processing in which a pixel value of a small-pixel RAW signal of the pixel of interest is blended with a pixel value of the large-pixel RAW signal of the pixel of interest;
comparing the pixel value of the large-pixel RAW signal of the pixel of interest with a saturation determination threshold and outputting a saturation determination value indicating whether or not the large-pixel RAW signal of the pixel of interest is saturated; and
selecting, according to the saturation determination value, whether to output the blending ratio as it is or by replacing the blending ratio with 1.

Note that, the present embodiment is not limited to the embodiments described above, and various alterations can be made without departing from the gist of the present disclosure. Furthermore, the effects described herein are merely examples and are not limited, and other effects may be provided.

### REFERENCE SIGNS LIST

11 Signal processing unit
21 Blending ratio calculation unit
22 α blending processing unit
31 First tap generation unit
32 Luminance generation unit
33 Maximum value selection unit
34 Saturation determination unit
35 First selector
36 Calculation unit
37 Second selector
38 Second tap generation unit
39 Low-pass filter processing unit
40 Third selector
51 Image processing system
61 Sensor module
62 Viewing device
63 Sensing device
71 Image sensor
81 Processing unit
82 User interface
83 Imaging signal processing unit
84 Imaging DNN
85 Display
91 Processing unit
92 ADAS
93 Recognition signal processing unit
94 Recognition DNN

1. A signal processing device comprising:
a calculation unit that compares a reference signal based on a large-pixel RAW signal of a pixel of interest with a threshold, and calculates a blending ratio for use in blending processing in which a pixel value of a small-pixel RAW signal of the pixel of interest is blended with a pixel value of the large-pixel RAW signal of the pixel of interest;
a saturation determination unit that compares the pixel value of the large-pixel RAW signal of the pixel of interest with a saturation determination threshold, and outputs a saturation determination value indicating whether or not the large-pixel RAW signal of the pixel of interest is saturated; and
a first selection unit that selects, according to the saturation determination value, whether to output the blending ratio as it is or by replacing the blending ratio with 1.

2. The signal processing device according to claim 1, wherein
a luminance value generated from pixel values of a plurality of pixels with the pixel of interest being a center is used as the reference signal.

3. The signal processing device according to claim 1, further comprising:
a tap generation unit that generates the blending ratio of a tap within a predetermined range with the pixel of interest being a center from the blending ratio output from the first selection unit; and
a low-pass filter processing unit that applies a low-pass filter to the blending ratio of the tap.

4. The signal processing device according to claim 3, further comprising
a second selection unit that outputs the blending ratio as it is in a case where the blending ratio of the pixel of interest before application of the low-pass filter is 1, and outputs the blending ratio of the pixel of interest after application of the low-pass filter in a case where the blending ratio of the pixel of interest before application of the low-pass filter is not 1.

5. The signal processing device according to claim 1, wherein
the saturation determination value is output as a saturation flag to be referred to by a sensing device that performs recognition processing using an image with a wide dynamic range, the image to which the blending processing has been applied.

6. A signal processing method comprising:
comparing a reference signal based on a large-pixel RAW signal of a pixel of interest with a threshold and calculating a blending ratio for use in blending processing in which a pixel value of a small-pixel RAW signal of the pixel of interest is blended with a pixel value of the large-pixel RAW signal of the pixel of interest;
comparing the pixel value of the large-pixel RAW signal of the pixel of interest with a saturation determination threshold and outputting a saturation determination value indicating whether or not the large-pixel RAW signal of the pixel of interest is saturated; and
selecting, according to the saturation determination value, whether to output the blending ratio as it is or by replacing the blending ratio with 1.

7. A program for causing a computer of a signal processing device to perform signal processing comprising:
comparing a reference signal based on a large-pixel RAW signal of a pixel of interest with a threshold and calculating a blending ratio for use in blending processing in which a pixel value of a small-pixel RAW signal of the pixel of interest is blended with a pixel value of the large-pixel RAW signal of the pixel of interest;
comparing the pixel value of the large-pixel RAW signal of the pixel of interest with a saturation determination threshold and outputting a saturation determination value indicating whether or not the large-pixel RAW signal of the pixel of interest is saturated; and
selecting, according to the saturation determination value, whether to output the blending ratio as it is or by replacing the blending ratio with 1.
